(19) United States
(12) Patent Application Publication
(10) Pub. No.: US 2004/0059463 A1
(43) Pub. Date: Mar. 25, 2004

(54) Active control center for use with an automatic dispensing system for prescriptions and the like

(75) Inventor: Michael E. Coughlin, Mission Hills, KS (US)

Correspondence Address: HOVEY WILLIAMS LLP, 2405 GRAND BLVD., SUITE 400, KANSAS CITY, MO, 64108, US

(73) Assignee: SCRIPTPRO LLC

(21) Appl. No.: 10/464,904

(22) Filed: Jun. 18, 2003

Related U.S. Application Data
(60) Provisional application No. 60/391,525, filed on Jun. 24, 2002.

(51) Int. Cl. G06F 7/00

(52) U.S. Cl. 700/229; 700/226

(57) ABSTRACT

An active control center (10) for automatic retrieval and storage of filled medicament vials dispensed from an automatic dispensing system (12). The control center (10) broadly comprises a cabinet (14); a slot matrix (16) positioned on the cabinet (14) and having a plurality of slots (18), wherein each slot (18) is configured for holding at least one medicament vial; an infeed conveyor (20) for transporting a vial from the automatic dispensing system (12) to the active control center (10); at least one vial dimension sensor (22) for determining at least one dimension of the vial; a computer-controlled mechanical loading mechanism (24) for retrieving the vial from the infeed conveyor (20) and moving the vial to the slot matrix (16); a slot sensor (26) contained within each slot (18) for determining how many vials are held within the slot (18); and a control system (28) for controlling operation of the infeed conveyor (20), the vial dimension sensor (22), the computer-controlled mechanical loading mechanism (24); and the slot sensor (26) in response to prescriptions received from a host computer (30).

### RELATED APPLICATION

This non-provisional utility application relates to and claims the priority benefit of U.S. provisional application entitled “ACTIVE CONTROL CENTER FOR MEDICAMENT DISPENSING SYSTEM,” Serial No. 60/391,525, filed Jun. 24, 2002, which is hereby incorporated into the present non-provisional application by reference.

### BACKGROUND OF THE INVENTION

1. Field of the Invention

The present invention relates to automatic dispensing systems which are operable to automatically fill and dispense prescription vials. More particularly, the invention relates to an active control center for automatically retrieving a filled prescription vial dispensed from an automatic dispensing system and locating the filled prescription in a storage unit for subsequent retrieval by an operator.

2. Description of the Prior Art

Automatic dispensing systems (“ADSs”), such as the one disclosed in U.S. Pat. No. 5,337,919, have been developed to assist pharmacists in the filling and dispensing of prescriptions. ADSs are extremely helpful in automatically filling prescription vials with medicaments; however, busy pharmacies often do not have enough pharmacists, technicians, or other operators available to retrieve and store the vials as quickly as an ADS outputs the vials. It is therefore common for filled vials to be lined up on an outfeed conveyor of the ADS, waiting for retrieval and storage by the operator. When the operator wishes to retrieve a particular patient's filled vial, the operator must look at and read each vial label on the outfeed conveyor until finding the correct vial. This method of retrieving filled vials is time-consuming and presents a possibility for error, since the operator may easily pick up the wrong vial in search of the patient's vial. If the patient has several filled prescriptions corresponding to several filled vials, the operator must look through even more vials for all of the patient's vials. Further, if the ADS is filling the vials faster than the operator can retrieve the vials, place caps on the vials, and store the vials, then the operator may likely store the vials on a counter top in the pharmacy. This presents the possibility of vials becoming disorganized, or of even more concern, vials being knocked over. Since the vials are not yet capped, medicament may spill onto the counter top or onto the floor. Further, there is the possibility other items may inadvertently be placed in the vials, such as other medicaments or particulates, such as dust accumulated on the counter top or floor.

If the pharmacy does provide multiple pharmacists, technicians, or other operators to retrieve, cap, and store the filled vials exiting the ADS, one or more persons are necessarily moving around the outfeed conveyor of the ADS. Since the area around the conveyor is relatively small, these persons are likely to bump into each other or otherwise cause a disruptive work environment. Further, with multiple persons retrieving the filled vials, the vials may become misplaced, or the contents of the vials may be spilled. It is also possible that one or more of the vials dispensed for a given patient may be retrieved by one operator while other vial(s) for the same patient may be retrieved by another operator. This may cause confusion, and when this happens, the patient may inadvertently leave the pharmacy without all of the required vials. Requiring additional operators for managing retrieval and storage of filled vials also increases the overall operating costs of the pharmacy.

Once the operator finds the correct vial for the patient, the vial is usually packaged in a bag having a label identifying the patient's name for whom the vial is intended. If the patient requires multiple vials, all vials would normally be packaged in the same bag. A prescription label for each prescription stored in the bag is then normally stapled to the bag. The bag is then stored, normally in alphabetical order, in a bin or other storage receptacle. As bags for various patients are stored in the bin, the bags are bunched together, which often makes it difficult to find a bag for a particular patient. Further, if a bag is mistakenly placed in the bin out of alphabetical order, upon retrieval of the bag, the operator is required to conduct a more extensive search of the stored bags for the desired bag.

If the patient has several prescriptions corresponding to several filled vials, all the vials should be packaged in the same bag for retrieval by the operator. However, it is common for multiple prescription vials to be packaged in separate bags for a variety of reasons. For example, if prescriptions are entered into a control system of the ADS at separate times, as opposed to being entered at approximately the same time, then the vials containing the prescribed medicament will exit the ADS at separate intervals. The operator retrieving the vials from the ADS outfeed conveyor will then likely package the vials as they exit the ADS, as opposed to retrieving a vial for a patient, recognizing that other vials will be forthcoming from the ADS, and temporarily setting the retrieved vial aside to wait for the other vials for the patient to exit the ADS. When the last vial for the patient has exited the ADS, the operator must then retrieve all vials for the patient that have been set aside, package the vials in a bag, and store the bag in alphabetical order in the storage bin. If the operator sets aside multiple vials for multiple patients, the counter top of the pharmacy is likely to become full with prescription vials awaiting packaging, which increases the possibility of misplacing a vial or of even more concern, incorrectly packaging a vial in the wrong bag.

To alleviate some of the problems associated with retrieving dispensed vials, ADSs are often provided with a control center or other end unit, wherein prescription vials filled with medicaments are conveyed to the control center via the outfeed conveyor of the ADS. Most prior art control centers are static in that they are simply a cabinet or handling station at which the operator retrieves a filled vial from the outfeed conveyor, places a cap on the vial, packages the vial in a bag or other package, and stores the vial in a storage receptacle or bin based on a patient's name.

Automated control centers have been developed which are operable to automatically store the vials exiting the ADS. Unfortunately, prior art automated control centers are limited to storing only one prescription vial per a slot or compartment. Additionally, prior art automated control centers store the vial based on a prescription number associated with the vial, as opposed to storing the vial based on a patient name for whom the vial is intended. This is especially inconvenient for several reasons. First, many patients now receive more than one prescription at a time, and thus, more than one prescription vial will be associated with each patient. Since prior art automated control centers are only operable to store one vial per a slot, an operator retrieving stored vials for a patient must retrieve vials from several different slots. Further, because the slots in which the vials for the patient are stored are not necessarily next to each other, or even proximate to each other, the operator is required to look for vials at several various locations within the storage unit.

Second, prior art automated control centers are only operable to store the vial for the patient under the prescription number, and thus any indicator for the slot in which the vial is stored only displays the prescription number. The operator is then required to cross-reference the prescription number to the patient name by either viewing the prescription number on paperwork for the prescription, viewing the prescription number on the indicator for the slot, and determining if the numbers match, or viewing the prescription number on a display, such as a computer monitor, and matching the prescription number to the number on the indicator. This is time-consuming and prone to error since the operator must match prescription numbers that are often several digits in length.

There is therefore a need for an improved control center that overcomes the limitations of the prior art. More particularly, there is a need for a control center that automatically retrieves a filled prescription vial dispensed from an automatic dispensing system and locates the filled vial in a storage unit for subsequent retrieval by an operator. There is also a need for a control center operable to store more than one vial in a slot. Additionally, there is a need for a control center operable to collate multiple vials for a patient in one slot. Further, there is a need for a control center operable to store a vial for a patient based on the patient's name, as opposed to a prescription number associated with the vial. Further yet, there is a need for a control center that is operable to collate and store multiple vials for a patient within the same slot.

### SUMMARY OF THE INVENTION

The present invention solves the above-described problems and provides a distinct advance in the art of control centers that cooperate with automatic dispensing systems (“ADSs”) operable to automatically fill and dispense prescription vials. More particularly, the present invention provides an active control center (“ACC”) that automatically retrieves a filled vial exiting the ADS and stores the vial in a storage unit according to a storage algorithm, wherein the storage algorithm is dependent on a patient name for whom the vial is intended and an availability of an open position in the storage unit.

The ACC of the present invention broadly includes a cabinet or other supporting structure; a slot matrix having a plurality of compartments or slots; an infeed conveyor; at least one vial dimension sensor; a computer-controlled mechanical loading mechanism; a slot sensor mounted within each slot; and a control system.

The cabinet is preferably positioned generally adjacent to the ADS and is configured for housing electronics associated with the ACC, a printer, a scanner, a keyboard drawer, a bin for holding a plurality of caps for the vials, and other necessary supplies. The cabinet may be a separate structure from the ADS or may be integrally formed with the ADS.

The slot matrix is positioned on a top of the cabinet and may be a separate structure from the cabinet or may be integrally formed with the cabinet. The plurality of slots formed in the slot matrix are configured to store filled medicament vials. Each slot is preferably configured for holding two vials but may hold fewer or more vials.

The infeed conveyor may be an outfeed conveyor of the ADS or may be a separate conveyor mounted to an outfeed conveyor of the ADS. The infeed conveyor is preferably mounted on the top of the cabinet, such that the infeed conveyor is operable to transport filled prescription vials from the ADS to the ACC.

The vial dimension sensor includes a first vial dimension sensor for measuring a height of each vial and a second vial dimension sensor for measuring a diameter of each vial. The vial dimension sensors are each preferably mounted on the infeed conveyor. Each vial dimension sensor preferably includes a plurality of infrared light emitting diodes (“LEDs”) and a plurality of receivers for sensing the dimensions of each vial.

The loading mechanism is positioned on the top of the cabinet and is operable to automatically retrieve the vials from the infeed conveyor and store the vials in the slot matrix. The loading mechanism includes a base secured within the cabinet, a plate lying generally parallel to the base and operable to rotate about an axis generally perpendicular to the plate, a first motor for driving rotation of the plate, a vertical tower extending upwardly from the plate, a horizontal grasping arm secured generally perpendicular to the tower and operable to move vertically along a length of the tower, a second motor for driving the horizontal grasping arm along the length of the tower, a third motor for driving the horizontal grasping arm in a horizontal direction, and a grasping member secured to the horizontal grasping arm for grasping the vial and locating the vial in the slot matrix.

The slot sensor mounted within its slot includes a plurality of LEDs and respective receivers, substantially similar to the LEDs and receivers of the vial dimension sensors, for continuously monitoring the number and location of vials stored within the slot.

The control system includes a computing device, a slot controller mounted within each slot, a central slot controller, a loading mechanism controller, an input device, an indicia reader, and one or more displays. The control system is preferably integrated with a control system of the ADS.

The computing device is preferably a computer that broadly comprises any processor capable of being programmed and includes a memory on which at least one database may be stored.

The slot controller mounted within its slot is operable to control operation of the slot sensor mounted within the slot and an indicator. The indicator is preferably a vacuum fluorescent display positioned adjacent to the slot and operable to indicate a location of the slot.

The central slot controller controls operation of each of the slot controllers for each of the slots. The central slot controller is operable to transmit information to and receive information from each of the slot controllers.

The loading mechanism controller controls operation of the loading mechanism. As such, the loading mechanism receives information from the control system corresponding to slot locations within which the vials are to be stored and instructs the loading mechanism to load the vials in the assigned slots.

The input device may be a keyboard, keypad, fingerprint reader, mouse, etc. An operator of the ACC uses the input device to input identifying information for a patient, such as the patient's name, to facilitate locating stored vials in the ACC.

The indicia reader is preferably a bar code reader for scanning a bar code of a prescription for the patient. Paperwork for the prescription preferably includes the bar code identifying the prescription.

The display is preferably a flat screen computer monitor mounted on a front face of the slot matrix for easy viewing by the operator.

In operation, a prescription for a patient is entered into the control system of the ADS. The operator may enter identifying information for the prescription, such as the patient's name. Further, the control system of the ADS may equate the prescription with a particular bar code, and such bar code may be placed on a subsequently filled vial.

Once the prescription is entered into the control system of the ADS, the ADS fills a vial with the prescribed medicament. The filled vial is transported to the ACC via the infeed conveyor. The vial's height and diameter are measured by the first and second vial dimension sensors, respectively. Once the dimensions of the vial are measured, the control system of the ACC determines a slot location in the slot matrix within which to store the vial. The location is dependent on the availability of open slots within the slot matrix and whether filled prescription vials for the patient have already been stored and not yet retrieved. Thus, the control system stores and collates vials based on the patient's name. Once the control system determines the slot in which to store the vial, the control system instructs the loading mechanism to store the vial in the slot.

When an operator of the ACC desires to retrieve the vial, the operator may input the identifying information for the prescription, such as the patient's name, into the control system via the input device. Alternatively, the operator may scan the bar code on the paperwork of the prescription using the indicia reader. The control system then instructs the indicator for the slot to flash, which indicates the slot location of the desired vial. The indicator also preferably displays the patient's name, so that the operator may also locate the correct slot by reading each indicator.

By constructing an active control center as described herein, numerous advantages are realized. For example, the ACC of the present invention assists pharmacists or other operators in locating vials filled by an ADS and dispensing the vials to patients. Additionally, the ACC significantly reduces the amount of time that pharmacists or other operators spend on retrieving and storing vials filled by the ADS. Further, the ACC eliminates errors associated with manual retrieval and storage of filled vials. Further yet, the ACC eliminates the need for multiple pharmacists or operators to retrieve and store the filled vials, thus decreasing the operating costs of the pharmacy. The ACC of the present invention also provides a control center that is operable to store more than one medicament vial per a slot. Additionally, the ACC is operable to associate a stored vial with a patient based on the patient's name, as opposed to merely associating the vial with the patient based on a prescription number. The ACC is also operable to store or collate all vials for a patient in one slot.

These and other important aspects of the present invention are described more fully in the detailed description below.

### BRIEF DESCRIPTION OF THE DRAWING FIGURES

A preferred embodiment of the present invention is described in detail below with reference to the attached drawing figures, wherein:

FIG. 1 is an isometric view of an automatic dispensing system (“ADS”) cooperating with an active control center (“ACC”) constructed in accordance with a preferred embodiment of the present invention;

FIG. 2 is a perspective view of a compartment or slot of the active control center, wherein the slot is configured to hold at least one prescription vial;

FIG. 3 is an isometric view of two sets of holding members configured to be secured within the slot, wherein each set of holding members is operable to hold one prescription vial;

FIG. 4 is a bottom view of a slot controller for positioning within the slot, particularly illustrating a plurality of light emitting diodes (“LEDs”) and respective receivers;

FIG. 5 is a plan view of an infeed conveyor for conveying the prescription vials from the ADS to the ACC of the present invention, wherein a pair of rollers are shown in broken line;

FIG. 6 is an exploded isometric view of a first vial dimension sensor for measuring a height of the vial, particularly illustrating a plurality of LEDs and respective receivers;

FIG. 7 is a bottom view of a second vial dimension sensor for measuring a diameter of the vial, particularly illustrating a plurality of LEDs and respective receivers;

FIG. 8 is an isometric view of a computer-controlled mechanical loading mechanism of the ACC, particularly illustrating the infeed conveyor and first and second vial dimension sensors;

FIG. 9 is a fragmentary isometric view of the loading mechanism, particularly illustrating a horizontal grasping arm and grasping member;

FIG. 10 is an isometric view of a middle support member of the grasping arm;

FIG. 11 is a plan view of the grasping member;

FIG. 12 is a cross-sectional view of the grasping member taken along line 12-12 of FIG. 11;

FIG. 13 is a schematic of the components of a control system of the ACC;

FIG. 14 is a flow diagram illustrating steps performed by the ACC for storage of a vial;

FIG. 15 is a flow diagram illustrating steps performed by the control system for determining in which slot to store the vial; and

FIG. 16 is a screen capture illustrating the arrangement and location of the slots in the ACC for viewing on a display.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

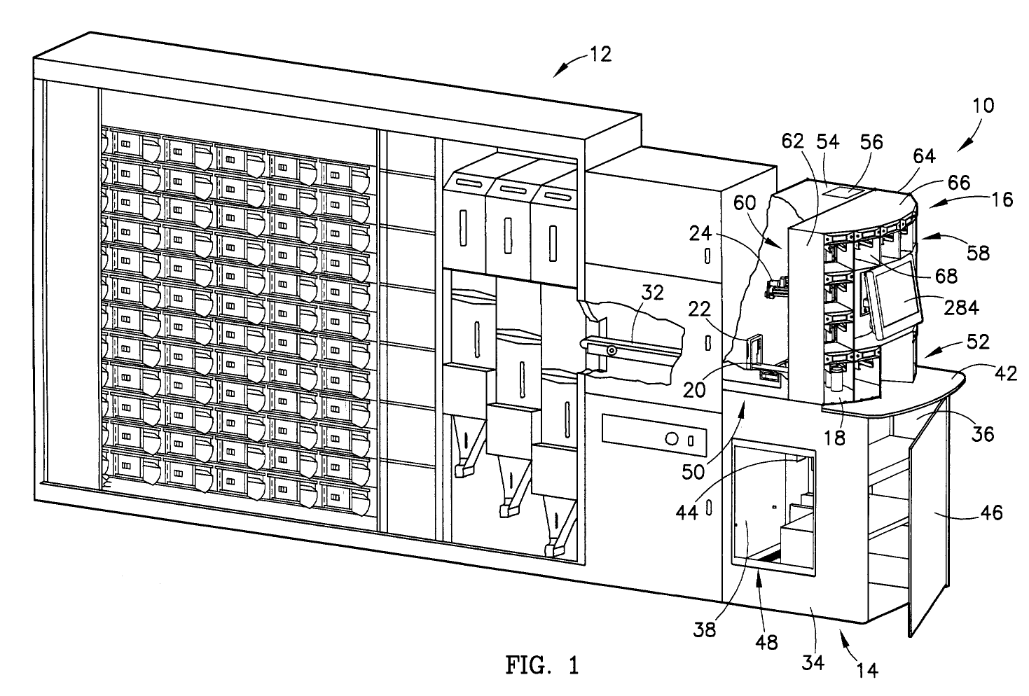

Turning now to the drawing figures, and particularly FIGS. 1, 2, and 13, an active control center (“ACC”) 10 cooperating with an automated dispensing system (“ADS”) 12 constructed in accordance with a preferred embodiment of the invention is illustrated. The ACC 10 is operable to retrieve and store filled and labeled prescription vials exiting the ADS and broadly includes a cabinet 14, table, or other support structure; a slot matrix 16 positioned on a top of the cabinet 14 and having a plurality of compartments or slots 18, wherein each slot 18 is configured for holding at least one prescription vial; an infeed conveyor 20 for transporting a vial from the ADS 12 to the ACC 10; at least one vial dimension sensor 22 for determining at least one dimension of the vial; a computer-controlled mechanical loading mechanism 24 for retrieving the vial from the infeed conveyor 20 and moving the vial to the slot matrix 16; a slot sensor 26 contained within each slot 18 for determining how many vials are held within the slot 18; and a control system 28 for controlling operation of the infeed conveyor 20, the vial dimension sensor 22, the computer-controlled mechanical loading mechanism 24, and the slot sensor 26 in response to prescriptions (“scripts”) received from a host computer 30.

As noted above, the present invention cooperates with the ADS 12, such as, for example, the SP 200 Robotic Prescription Dispensing System manufactured and sold by ScriptPro LLC of Mission, Kans. Various aspects of ADSs 12 are embodied in U.S. Pat. Nos. 5,337,919, 5,713,487, and 5,762,235, which are hereby incorporated by reference. Briefly, the ADS 12 receives scripts via the host computer 30. The ADS 12 then fills vials with medicament corresponding to the script, and the filled vials are transported, via an outfeed conveyor 32, to an end unit, where an operator retrieves the filled vials from the outfeed conveyor 32, places caps on the vials, and stores the vials in a predetermined storage unit or packages the vials for receipt directly by patients. The ACC 10 of the present invention replaces the end unit by receiving the vials from the outfeed conveyor 32 and automatically storing the vials by patient, prescription, or other storage scheme without input or handling by the operator.

In more detail, the cabinet 14 is positioned generally adjacent to the ADS 12 and may be secured to the ADS 12, as illustrated in FIG. 1. The cabinet 14 includes left and right side walls 34,36, a rear wall 38, and a counter top 42 forming an enclosure in which electronics associated with the ACC 10, a printer, a scanner, a keyboard drawer, a bin for holding a plurality of caps for the vials, and other supplies are located. The rear wall 38 is preferably positioned generally adjacent to the ADS 12 and includes at least one opening 44 through which electronics housed in the cabinet 14 may cooperate with or otherwise be connected to the ADS 12. An access door 46 is preferably positioned on a front face of the cabinet 14 so that an operator of the ACC 10 may access and otherwise service the items housed within the cabinet 14. The left side wall 34 also includes an access opening 48 and cover (not shown) through which the operator may access and otherwise service the items housed within the cabinet 14.

The cabinet 14 may generally be divided into a rear section 50 and a front section 52. The counter top 42 preferably partially covers the top of the cabinet 14 at the front section 52. The top of the cabinet 14 at the rear section 50 is preferably enclosed by a rear section cover 54 that is made of aluminum or sheet metal. The cover 54 protects the computer-controlled mechanical loading mechanism 24 from dust, debris, and other damaging effects. The rear section cover 54 may include an access panel 56 for servicing the loading mechanism 24. The cabinet 14 is preferably formed primarily of aluminum or steel but may be formed of other suitable materials as a matter of design choice. The cabinet 14 is preferably separate from the ADS 12 but may be integrally formed with the ADS 12 as a matter of design choice.

The slot matrix 16 is preferably positioned on the top of the cabinet 14 and substantially adjacent to the counter top 42, such that together, the slot matrix 16 and counter top 42 generally cover the top of the cabinet 14 at the front section 52. The slot matrix 16 is preferably formed of aluminum or steel but may be formed of other suitable materials as a matter of design choice. Further, the slot matrix 16 is preferably formed with the cabinet 14 but may be separate from the cabinet 14 as a matter of design choice. The slot matrix 16 is generally semi-circular in horizontal cross section, extends upwardly from the cabinet 14, and has front and rear faces 58,60, left and right side walls 62,64, a top wall 66, and intersecting vertical and horizontal interior walls 68. The interior walls 68 define the slots 18 for holding the vials. The preferred slot matrix 16 is a 4×6 matrix of slots 18, wherein each slot 18 is configured for holding at least one vial and preferably two vials. A total of fourteen slots 18 are preferably formed in the slot matrix 16, and the slot matrix 16 is configured for holding twenty-eight vials at once.

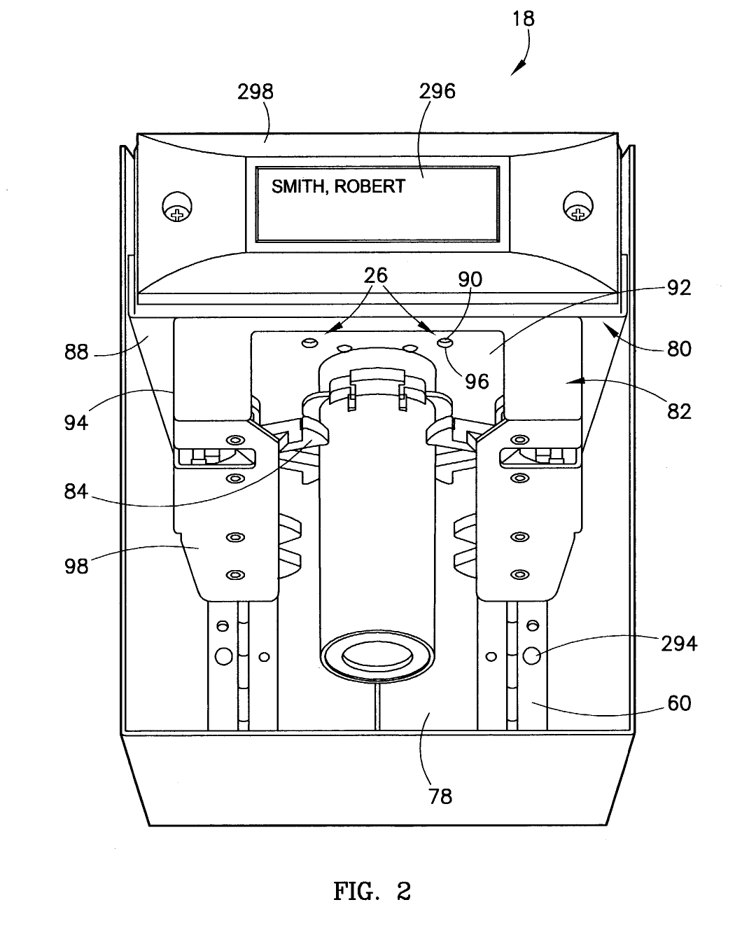

Each slot 18 is preferably approximately 16 cm deep, 14 cm wide, and 13 cm high, although the depth may range between 6 cm and 26 cm, the width may range between 4 cm and 24 cm, and the height may range between 5 cm and 23 cm, depending on a size of a vial to be stored in the slot 18 and the number of vials to be stored in the slot 18. Preferably, each slot 18 is sized and configured to hold two vials, although fewer or more vials are possible depending on the size of the slot matrix 16. Vials may be stored at front and rear positions within the slot 18 as viewed from FIG. 2, with the front position being the position closest to the front face 58 of the slot matrix 16, and the rear position being the position closest to the rear face 60 of the slot matrix 16.

As best illustrated in FIG. 2, a pair of one-way swinging doors 78 is positioned at an end of each slot 18 proximate to the rear face 60 of the slot matrix 16, the purpose of which will be described below. A mounting cage 80, a holding bracket 82, and at least one, and preferably two, holding members 84 for holding stored vials are mounted or contained within each slot. Each mounting cage 80 is preferably positioned at an upper end of its slot 18 and has a bottom wall 88 that includes a plurality of openings 90, the purpose of which will also be described below. Each slot sensor 26 is preferably mounted within its mounting cage 80, as described in more detail below.

The holding bracket 82 is secured to the bottom wall 88 of the mounting cage 80 and includes a top wall 92 and a pair of side walls 94 that extend downwardly from the top wall 92. The top wall 92 includes a plurality of openings 96 preferably aligned with the plurality of openings 90 in the bottom wall 88 of the mounting cage 80, the purpose of which will be described below.

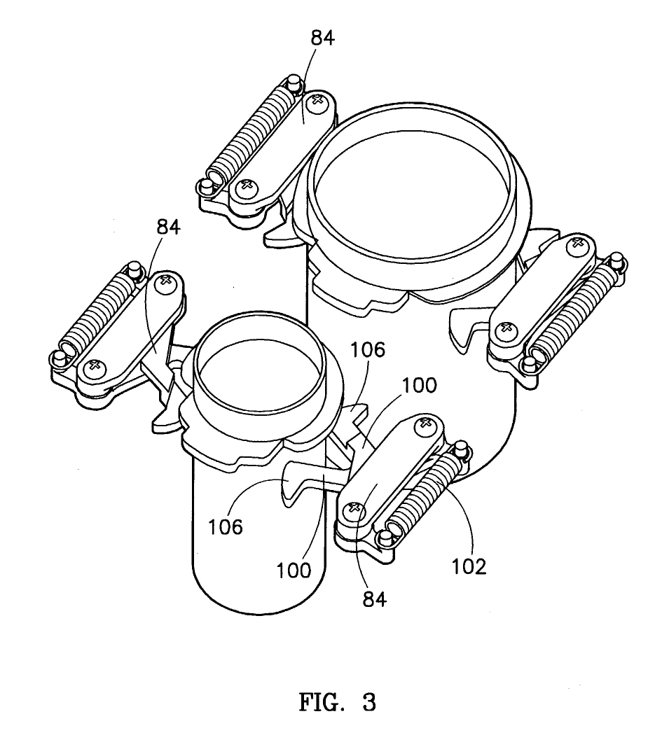

Each side wall 94 is provided with a shelf 98 on which the holding members 84 are pivotably secured, as illustrated in FIG. 2. The holding members 84, as illustrated in FIG. 3, are preferably generally scissor-like in motion and are each formed of dual arms 100 under tension from a coiled spring 102. Two opposing holding members 84 are used to hold each stored vial. An end of each arm 100 is provided with a catching member 106 that catches each vial. Due to the tension in the arms 100 from the spring 102, the catching member 106 of each arm 100 securely holds each vial placed into the slot 18 by the loading mechanism 24, as described in more detail below. Each vial is snapped into position within the slot 18 without the need for force and may easily be removed by an operator by simply grasping and pulling the vial from the holding members 84.

Turning now to FIGS. 1 and 5, the infeed conveyor 20 is preferably positioned on the top of the cabinet 14 at the rear section 50 of the cabinet 14. In preferable form, the infeed conveyor 20 is also the outfeed conveyor 32 of the ADS 12, such that the outfeed conveyor 32 extends onto the rear section 50 of the top of the cabinet 14. The infeed conveyor 20 preferably ends at approximately center of the cabinet 14 generally proximate to the slot matrix 16. Alternatively, the infeed conveyor 20 may be positioned substantially adjacent to an end of the outfeed conveyor 32 of the ADS 12, such that vials being transported on the outfeed conveyor 32 continuously move onto the infeed conveyor 20 without interruption. In addition to transporting the vials from the ADS 12, the infeed conveyor 20 serves as a retrieving station from which the computer-controlled mechanical loading mechanism 24 may retrieve the filled vials for storage in the slot matrix 16, as described in more detail below.

The infeed conveyor 20 includes a conveyor base 118 having a horizontal base 120 section preferably formed of metal. A pair of spaced-apart, transversely-extending rollers 122 are rotatably mounted to the conveyor base 118. A conveyor belt 124 is trained over the rollers 122 so that the belt 124 covers and rides over the horizontal base section 120. The rightmost roller 122 serves as a drive roller that is driven by a belt or chain 126 rotated by a conveyor motor 128.

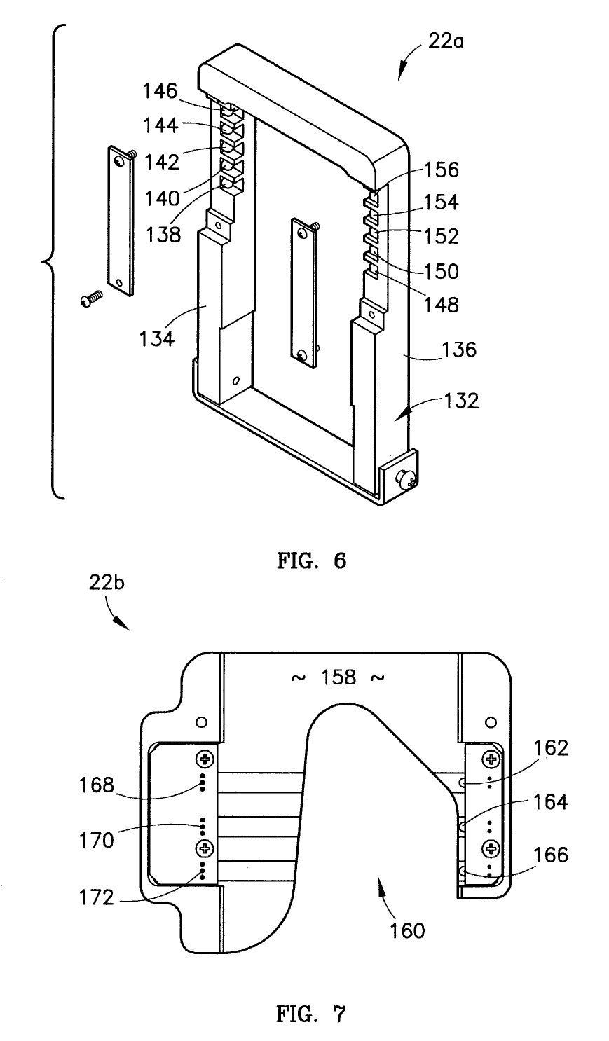

The present invention includes at least one, but preferably two, vial dimension sensors 22a,22b for measuring the dimensions of the vial being transported by the infeed conveyor 20, as illustrated in FIGS. 6 and 7. The first vial dimension sensor 22a is preferably a height sensor for measuring a height of the vial and is generally positioned at an exit of the ADS 12, as illustrated in FIG. 1. As illustrated in FIG. 6, the first vial dimension sensor 22a includes a generally upside-down U-shaped frame 132 having first and second sides 134, 136. Preferably, first, second, third, fourth, and fifth infrared light emitting diodes (“LEDs”) 138, 140, 142, 144, 146 and respective first, second, third, fourth, and fifth receivers 148, 150, 152, 154, 156 are mounted on the frame 132 of the first vial dimension sensor 22a. The LEDs 138, 140, 142, 144, 146 are preferably mounted on the first side 134 of the frame 132 at generally one-quarter inch intervals. Similarly, the receivers 148, 150, 152, 154, 156 are preferably mounted on the second side 136 of the frame at generally one-quarter inch intervals, such that infrared energy emitted by the first LED 138 may be received by the first receiver 148, infrared energy emitted by the second LED 140 may be received by the second receiver 150, etc. Thus, each receiver 148, 150, 152, 154, 156 is aligned to receive the infrared energy emitted by the respective LED 138, 140, 142, 144, 146. Although infrared LEDs 138, 140, 142, 144, 146 and receivers 148, 150, 152, 154, 156 are described, the first vial dimension sensor 22a may include any conventional optical-type sensor having an optical emitter and an optical detector.

If the infrared energy emitted by the first and lowest LED 138 is not blocked, i.e. the energy is received by the receiver 148, the control system 28 of the present invention calculates that no vial is on the conveyor 20. Similarly, if the energy emitted by the first LED 138 is blocked by the first receiver 148, but the energy emitted by the remaining LEDs 140, 142, 144, 146 is not blocked by the respective remaining receivers 150, 152, 154, 156, then the control system 28 calculates that the vial height corresponds to a small-sized vial. If the second LED 140 emits blocked energy, but the energy emitted by the third LED 142 is not blocked, then the control system 28 calculates that the vial height corresponds to the height of a medium-sized vial. Similarly, if the third LED 142 emits blocked energy, but the energy emitted by the fourth and fifth LEDs 144, 146 is not blocked, then the control system 28 calculates that the vial height corresponds to the height of a medium-sized vial. This is because manufacture sizes for vial heights are not generally consistent. If the energy emitted by the fourth LED 144 is blocked, but the energy emitted by the fifth LED 146 is not blocked, then the control system 28 calculates that the vial height corresponds to a large-sized vial. The fifth and highest LED 146 and receiver 156 are used to detect items of even larger heights than a large-sized vial. Since the LEDs 138, 140, 142, 144, 146 and respective receivers 148, 150, 152, 154, 156 are positioned in one-quarter inch intervals, the first vial dimension sensor 22a is operable to determine the height of the vial within a generally one-quarter inch accuracy. However, the first vial dimension sensor 22a may include fewer or more LEDs 138, 140, 142, 144, 146 and respective receivers 148, 150, 152, 154, 156, depending on the accuracy of the measured height desired.

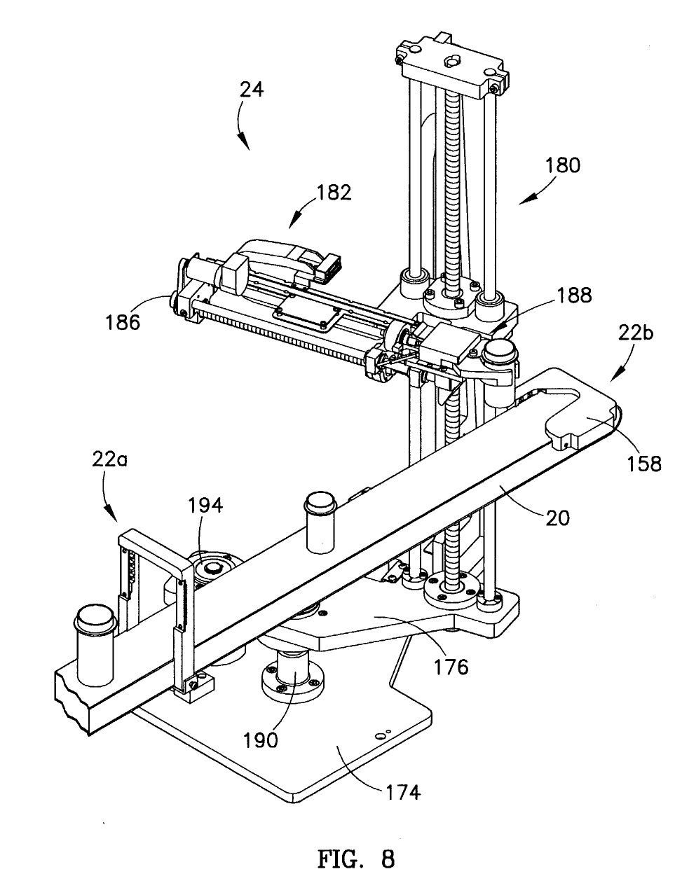

Turning to FIGS. 7 and 8, the second vial dimension sensor 22b is a diameter sensor for measuring a diameter of the vial. The sensor 22b is preferably positioned at the end of the infeed conveyor 20 proximate to the slot matrix 16, and a frame 158 of the sensor 22b lies generally flat with respect to the infeed conveyor 20. The frame 158 is generally square-shaped in transverse orientation and includes an arcuate cut-away 160 of a generally V-shape in which the vial is slid to measure the diameter. First, second, and third LEDs 162, 164, 166 and respective first, second, and third receivers 168, 170, 172, substantially similar to the LEDs 138, 140, 142, 144, 146 and receivers 148, 150, 152, 154, 156 of the first vial dimension sensor 22a, are mounted within the frame 158 at opposing sides, such that infrared energy emitted by the first LED 162 is positioned to be received by the first receiver 168, infrared energy emitted by the second LED 164 is positioned to be received by the second receiver 170, and infrared energy emitted by the third LED 166 is positioned to be received by the third receiver 172. As with the first vial dimension sensor 22a for measuring height, the second vial dimension sensor 22b is operable to measure the diameter of a vial corresponding to a small, medium, or large-sized vial.

The infeed conveyor 20 transports a vial into the second vial dimension sensor 22b and specifically into the sensor's cut-away 160. Once the vial is slid into the cut-away 160, the infrared energy emitted by one or more of the LEDs 162, 164, 166 is blocked so as to not be received by the respective receiver 168, 170, 172. Similar to the first vial dimension sensor 22a, the control system 28 is operable to calculate the diameter of the vial based on the number of LEDs 162, 164, 166 emitting blocked infrared energy. If the infrared energy from the first LED 162 is blocked, but the infrared energy emitted by the second and third LEDs 164,166 is not blocked, the control system 28 calculates that the vial diameter corresponds to the diameter of a small-sized vial. If the infrared energy from the first and second LEDs 164, 166 is blocked, but the infrared energy emitted by the third LED 166 is not blocked, the control system 28 calculates that the vial diameter corresponds to the diameter of a medium-sized vial. If the infrared energy from all three LEDs 162, 164, 166 is blocked, the control system 28 calculates that the vial diameter corresponds to the diameter of a large-sized vial. As with the first vial dimension sensor 22a, the second vial dimension sensor 22b may include fewer or more LEDs 162, 164, 166 and respective receivers 168, 170, 172, depending on the accuracy of the measured diameter desired. Further, although infrared LEDs 162, 164, 166 and receivers 168, 170, 172 are described, the second vial dimension sensor 22b may include any conventional optical-type sensor having an optical emitter and an optical detector.

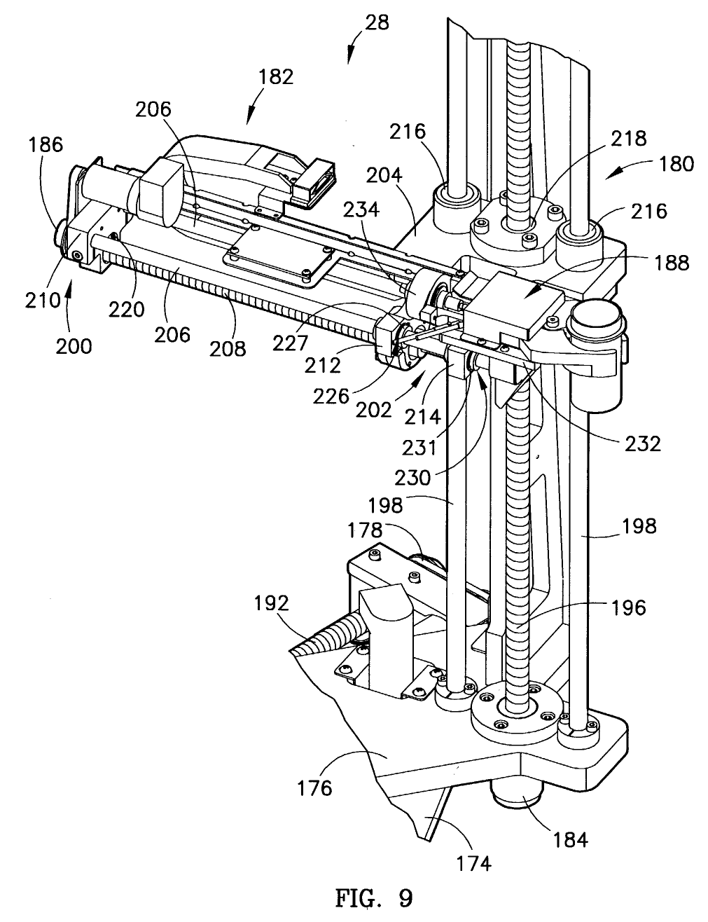

Turning to FIGS. 8 and 9, the computer-controlled mechanical loading mechanism 24 (hereinafter referred to as the “loading mechanism”) is positioned at the rear section 50 of the cabinet 14 and contained partially within the cabinet 14. The loading mechanism 24 broadly includes a base 174 secured within the cabinet 14, a plate 176 lying generally parallel to the base 174 and operable to rotate about an axis generally perpendicular to the plate 176, a first motor 178 for driving the rotation of the plate 176, a vertical tower 180 extending upwardly from the plate 176, a horizontal grasping arm 182 secured generally perpendicular to the tower 180 and operable to move vertically along a length of the tower 180, a second motor 184 for driving the horizontal grasping arm 182 along the length of the tower 180, a third motor 186 for driving the horizontal grasping arm 182 in a horizontal direction, and a grasping member 188 secured to the horizontal grasping arm 182 for grasping the filled vial and locating the vial in the slot matrix 16.

The loading mechanism 24 is preferably operable to move in three directions, which is most conveniently described in cylindrical coordinates of (r, z, θ). In the r-direction, the loading mechanism 24 is operable to travel approximately 9 inches, but the travel distance may range between 3 inches and 15 inches; in the z-direction, the loading mechanism 24 is operable to travel approximately 30 inches, but the travel distance may range between 10 inches and 50 inches; and in the θ-direction, the loading mechanism 24 is operable to rotate approximately 40° in a clockwise direction and 40° in a counter-clockwise direction for a total range of approximately 80°, but the angle of rotation may range between 10° and 70° in the clockwise direction and between 10° and 70° in the counter-clockwise direction.

The base 174 is mounted and secured within the cabinet 14 at the rear section 50 of the cabinet 14. The base 174 is preferably made of aluminum or other suitable material capable of supporting the weight of the loading mechanism 24. The first motor 178 and a main pivot shaft 190 are supported by the base 174, as illustrated in FIG. 8 and as described in more detail below.

The plate 176 is preferably positioned generally parallel to the base 174 and operable to rotate in the θ-direction of approximately±40°, as discussed above. The main pivot shaft 190 is secured between the base 174 and the plate 176 in a direction generally perpendicular to the plate 176. As discussed in more detail below, the plate 176 is operable to rotate about the main pivot shaft 190 in the θ-direction. The plate 176 also supports the vertical tower 180, as discussed below.

The first motor 178 is preferably a servo motor, and the control system 28 of the present invention is preferably in communication with the first motor 178. A first threaded 192 rod extends between the first motor 178 and a ball joint 194, which is secured to the plate 176 and extends downwardly therefrom. The ball joint 194 includes a threaded ball nut (not shown) through which the first threaded rod 192 is guided. The first motor 178 rotates the first threaded rod 192, which in turn linearly moves the ball joint 194 along the first threaded rod 192. The linear movement of the ball joint 194 is transferred to rotational movement of the plate 176 in the θ-direction about the main pivot shaft 190, as noted above. As can be understood, the first motor 178 is operable to rotate the plate 176 in both a clockwise and a counter-clockwise direction.

As noted above, the vertical tower 180 is supported by the plate 176 and extends upwardly therefrom. As illustrated in FIG. 9, the vertical tower 180 includes a second threaded rod 196 and a first pair of polished guide rods 198, the purpose of which will be described below.

The horizontal grasping arm 182 has first and second ends 200,202 and is secured to the vertical tower 180 via a securing member 204 that projects transversely from the arm 182 at the general second end 202 of the arm 182. The horizontal grasping arm 182 also includes a second pair of polished guide rods 206, a third threaded rod 208, and rear and middle support members 210,212 both configured to engage the third threaded rod 208, the purpose of which will be described below. A front support member 214 will be described below with respect to the grasping member 188.

The securing member 204 includes a first pair of guide holes 216 and a first threaded hole 218. The first pair of polished guide rods 198 of the vertical tower 180 are guided in and operable to slide within the first pair of guide holes 216 of the securing member 204, as illustrated in FIG. 9. The second threaded rod 196 of the vertical tower 180 cooperates with and is operable to be threaded through the first threaded hole 218 of the securing member 204, the purpose of which will be described below. The securing member 204 is configured to support the weight of the horizontal grasping arm 182 and to secure the arm 182 to the vertical tower 180.

The second and third motors 184,186 are preferably servo motors, and the control system 28 of the present invention is preferably in communication with the second and third motors 184,186. The second motor 184 is positioned on an underside of the plate 176 and preferably rotates the second threaded rod 196 of the vertical tower 180, thus actuating movement of the horizontal grasping arm 182 in the z-direction. Since the second threaded rod 196 is guided within the first threaded hole 218 of the securing member 204, the rotation of the second threaded rod 196 slides the securing member 204, and thus, the horizontal grasping arm 182, along the length of the vertical tower 180 in the z-direction. As can be understood, the second motor 184 is operable to move the horizontal grasping arm 182 in both an upward and a downward direction.

The rear support member 210 is preferably fixed at the first end 200 of the horizontal grasping arm 182 and includes an opening 220. The second pair of polished guide rods 206 of the arm 182 are secured with the rear support member 210. The third threaded rod 208 is secured within and operable to rotate within, but not be guided through, the opening 220 of the rear support member 210.

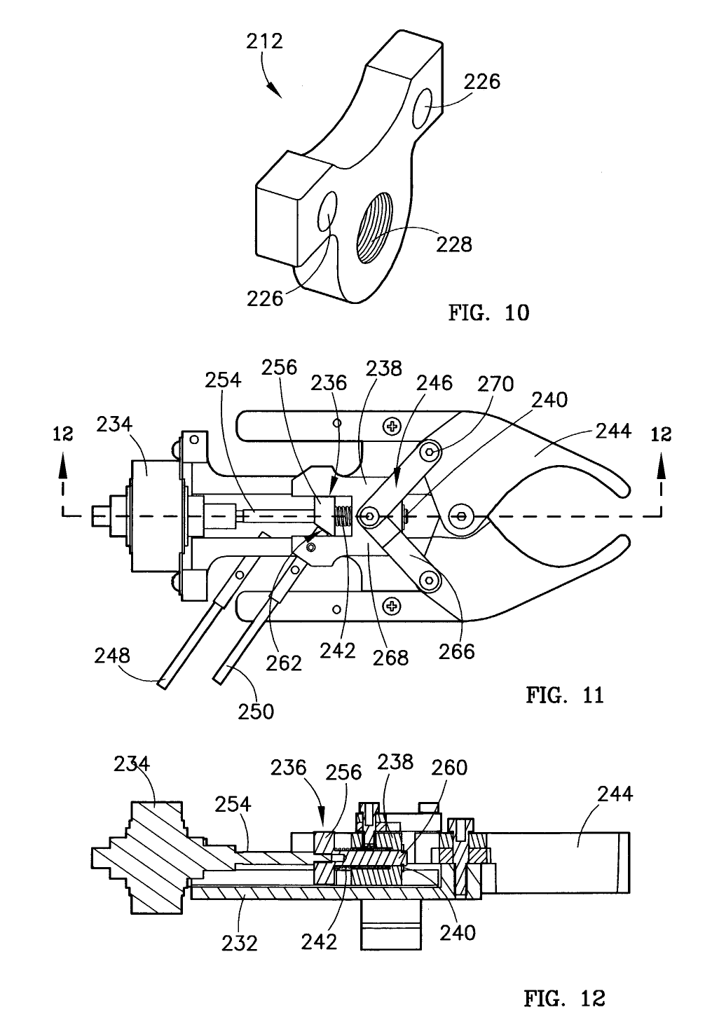

The middle support member 212 is preferably secured to the securing member 204. The middle support member 212 includes a second pair of guide holes 226 including bushings 227 and a second threaded hole 228, as illustrated in FIG. 10. The second pair of polished guide rods 206 are guided in and operable to slide within the second pair of guide holes 226 and bushings 227 of the middle support member 212. The third threaded rod 208 cooperates with and is operable to be threaded through the second threaded hole 228 of the middle support member 212. As discussed in more detail below, as the grasping arm 182 is moved in the r-direction, the second pair of polished guide rods 206 and the third threaded rod 208 are guided through the second pair of guide holes 226 and the second threaded hole 228, respectively.

The third motor 186, positioned at the first end 200 of the horizontal grasping arm 182, rotates the third threaded rod 208, which actuates movement of the horizontal grasping arm 182 in the redirection. Similar to the movement of the arm 182 in the z-direction, the rotation of the third threaded rod 208 through the second threaded hole 228 of the middle support member 212 allows the middle support member 212 to be guided along the second pair of polished guide rods 206 and the third threaded rod 208, thus moving the arm 182 in the redirection. Further, as can be understood, the third motor 186 is operable to move the horizontal grasping arm 182 in both a forward and a backward direction.

Turning now to FIGS. 11 and 12, the grasping member 188 is secured to the second-end 202 of the horizontal grasping arm 182 via the front support member 214, as illustrated in FIG. 9, and the front support member 214 is secured to the securing member 204. The front support member 214 includes a pair of openings 230 (only one opening can be seen in FIG. 9) including bushings 231 within which the second pair of polished guide rods 206 are secured.

The grasping member 188 broadly comprises a mounting member 232, a fourth motor 234, a spring pin 236, a cam block 238, a C-ring 240, a spring 242, a pair of jaws 244, a connecting link 246, a home sensor 228, and a gripping sensor 250.

The mounting member 232 is the base of the grasping member 188 on which the fourth motor 234 and the pair of jaws 244 are supported. The second pair of polished guide rods 206 are secured to the mounting member 232, such that together, the rear, middle, and front support members 210,212,214 and the mounting member 232 support the second pair of polished guide rods 206 and the horizontal grasping arm 182. Since the second pair of polished guide rods 206 are secured to the mounting member 232, the mounting member 232, and thus, the grasping member 188, are supported and otherwise secured to the second end 202 of the horizontal grasping arm 182.

The fourth motor 234 is preferably a linear stepper motor, and, as with the first, second, and third motors 178, 184, 186, the control system 28 of the present invention is preferably in communication with the fourth motor 234. The fourth motor 234 drives the grasping or clamping action of the grasping member 188, as described below. The fourth motor 234 includes a retractable motor shaft 254 that extends generally longitudinally from the motor 234.

The spring pin 236 includes a generally doughnut-shaped portion 256 having an inner opening 258 and a longitudinally-extending portion 260 that together form a general T-shape in vertical cross-section, as illustrated in FIG. 12. An outside face of the doughnut-shaped portion 256 includes an angled surface 262 that is configured to contact both the home sensor 228 and the gripping sensor 250 upon movement of the spring pin 236, as described in more detail below. The motor shaft 254 is threaded through the doughnut-shaped portion 256 of the spring pin 236, such that linear movement of the motor shaft 254 translates into linear movement of the spring pin 236.

The cam block 238 is generally U-shaped and includes a first inner diameter and a second outer diameter, both of which are not shown. The longitudinally-extending portion 260 of the spring pin 236 extends through the length of the inner diameter and is operable to extend through a front end 264 of the cam block 238 upon compression of the spring 242, as discussed in more detail below. The C-ring 240 is secured to an end of the longitudinally-extending portion 260 and prevents the spring pin 236 from receding back into the inner diameter of the cam block 238. Thus, the C-ring 240 travels with the longitudinally-extending portion 260 of the spring pin 236.

The spring 242 is coiled around the longitudinally-extending portion 260 and extends partially into the outer diameter of the cam block 238, as best illustrated in FIG. 12. The spring 242 travels with the spring pin 236, and not with the cam block 238, the purpose of which will be described below.

The pair of jaws 244 is preferably rotatably secured to the mounting member 232, such that the pair of jaws 244 is operable to open and close by operation of the fourth motor 234, as described below. The pair of jaws 244 is connected to or otherwise associated with the cam block 238 via the connecting link 246. The connecting link 246 is preferably a pair of links 266 formed in a general V-shape. Each link 266 has a first end 268 and a second end 270, wherein the first end 268 of each link 266 forms the vertex of the connecting link 246. The first end 268 of each link 266 is preferably pivotably secured to the cam block 238. The second end 270 of each link 266 is secured to a respective jaw 244 and is not operable to pivot.

The home sensor 228 is positioned on the underside of the mounting member 232 and is preferably operable to communicate with the control system 28. The gripping sensor 250 extends through a leg of the cam block 238 and is also operable to communicate with the control system 28. Both the home and gripping sensors 248,250 are configured to contact the angled surface 262 of the doughnut-shaped portion 256 of the spring pin 236. In a “home” position, the spring pin 236 is in a rearmost position, such that the home sensor 228 is in contact with the angled surface 262 of the spring pin 236. When the fourth motor 234 operates in a forward manner, the motor shaft 254 extends forward, which causes forward motion of the cam block 238. The motor 234 continues the forward motion until the gripping sensor 250 loses contact with the angled surface 262 of the spring pin 236. When the gripping sensor 250 loses contact with the spring pin 236, the control system 28 indicates a gripped position, and at such point, the jaws 244 are generally gripping the vial.

Once the vial is gripped, the control system 28 again measures the diameter of the vial as a security feature to ensure that the correct vial is being placed in the slot 18. The control system 28 measures the diameter from the number of steps the fourth motor 234 progresses from the home position to the gripped position, i.e. from contact with the home sensor 228 to loss of contact with the gripping sensor 250. The measured diameter using the grasping member 188 is confirmed with the earlier diameter measurement using the second vial dimension sensor 22b. If the measurements are not the same, the control system 28 generates an error message to alert the operator to take corrective action.

After the diameter is measured, the control system 28 instructs the motor 234 to be driven forward a predetermined number of steps to compress the spring 242 and increase the jaw force on the vial. The spring 242 is compressed by movement of the spring pin 236 in the forward direction while the cam block 238 remains stationary. Once the vial is placed in the slot 18, the grasping member 188 returns to the home position.

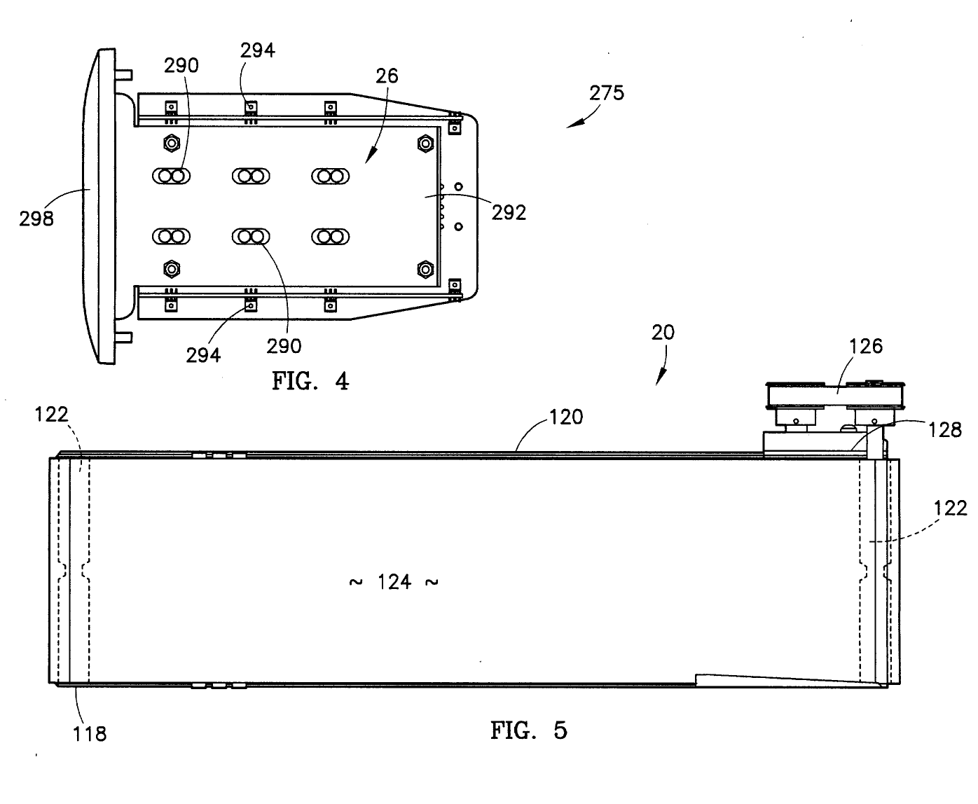

As noted above, each slot 18 preferably has mounted within it the slot sensor 26 for determining if a vial is held within the slot 18. The slot sensor 26 preferably includes a plurality of infrared light emitting diodes 290 (“LEDs”) mounted on a printed circuit board 292 (“PCB”), as illustrated in FIG. 4. The PCB 292 is preferably mounted within its mounting cage 80, such that the LEDs 290 shine inside a top of the vial, as illustrated in FIGS. 2 and 4. Infrared energy emitted from the LEDs 290 transmits through the openings 90 in the bottom wall 88 of the cage 80 and the openings 96 in the top wall 92 of the holding bracket 82. A plurality of receivers 294, also mounted on the PCB 292, are arranged to either side of each vial to receive the emitted infrared energy from the LEDs 290. Further, receivers 294 are positioned on either side of the one-way doors 78, the purpose of which will be described below.

If a vial is located in the front or rear positions within the slot 18, the infrared energy emitted by at least one of the LEDs 290 is blocked such that the infrared energy received by at least one of the receivers 294 is measurably reduced, which indicates that the vial is within the slot 18. Similarly, if the infrared energy emitted by all the LEDs 290 is received by the receivers 294, the control system 28 calculates that no vial is held in the slot 18. The LEDs 290 and receivers 294 are positioned such that the control system 28 can determine if no vial is positioned within the slot 18, if one vial is positioned in the front position and no vial is positioned in the rear position, if one vial is positioned in the rear position and no vial is positioned in the front position, or if two vials are positioned in the front and rear positions. Although infrared LEDs 290 and receivers 294 are described, the slot sensor 26 may include any conventional optical-type sensor having an optical emitter and an optical detector.

An indicator 296 is also mounted on and connected to the PCB 292, such that the indicator 296 faces towards the front face 58 of the slot matrix 16. The indicator 296 is preferably a vacuum fluorescent display (“VFD”) secured in a bezel 298, as illustrated in FIG. 2. The indicator 296 is operable to display a patient's name, script, or other identifying information so that an operator of the ACC 10 may quickly and easily determine the location of filled and held vials, as discussed in more detail below.

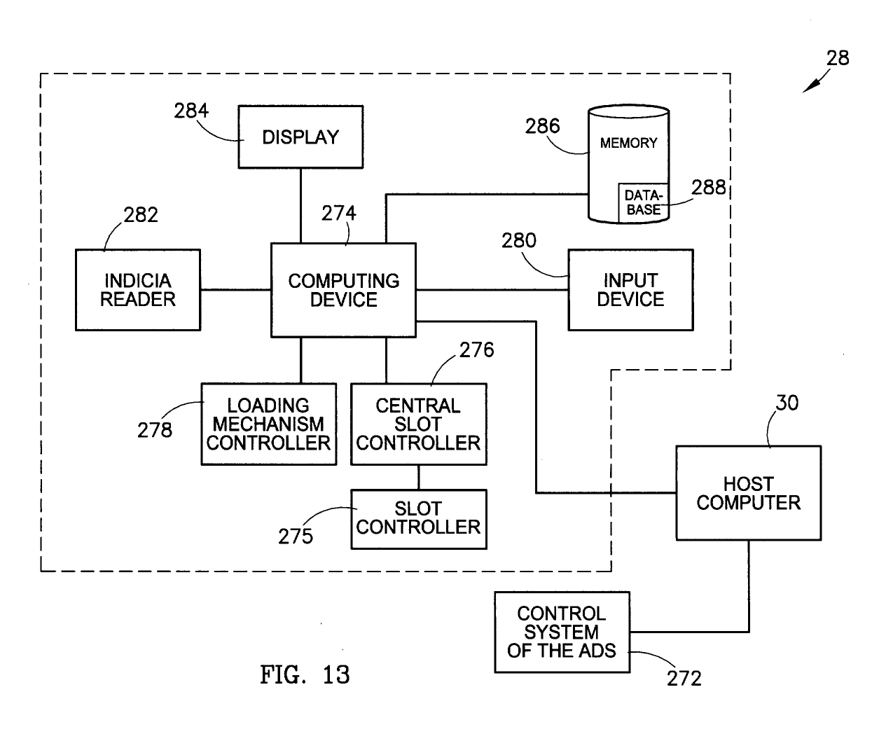

Turning now to FIGS. 13-15, the control system 28 of the present invention controls operation of the ACC 10 and is integrated with a control system 272 of the ADS 12. The control system 272 of the ADS 12 receives data corresponding to prescriptions inputted to the host computer 30. The host computer 30 may be any pharmacy computer running a pharmacy automation program such as provided by Zadall Computer Systems. With respect to the ACC 10 of the present invention, the control system 28 communicates with and controls operation of the infeed conveyor 20, the first vial dimension sensor 22a for determining the height of the vial, the second vial dimension sensor 22b for determining the diameter of the vial, the computer-controlled mechanical loading mechanism 24, and the slot sensor 26.

The control system 28 broadly includes a computing device 274, such as a computer, a slot controller 275 mounted within each slot 18 for controlling operation of the slot sensor 28 and the indicator 296 of each slot 18, a central slot controller 276 for controlling operation of each slot controller 275, a loading mechanism controller 278 (“LMC”) for controlling operation of the computer-controlled mechanical loading mechanism 24, an input device 280, such as a keyboard, keypad, fingerprint reader, mouse, etc., an indicia reader 282, such as a bar code reader, and at least one display 284 that serves as an operator interface. The display 284 is preferably a flat screen computer monitor mounted in a general center of the front face 58 of the slot matrix 16, as illustrated in FIG. 1.

The computing device 274 may broadly comprise any processor capable of being programmed and preferably also includes a memory 286 on which at least one database 288 may be stored. The computing device 274 communicated with and controls operation of the other components of the control system 28.

As noted above, operation of the slot sensor 26 and indicator 296 for each slot 18 is controlled by the individual slot controller 275. Each of the slot controllers 275 mounted within each of the slots 18 is controlled by the central slot controller 276, and thus, the central slot controller 276 is operable to transmit information to and receive information from each slot controller 275. Each slot controller 275 continuously monitors how many vials are stored in the slot 18 using the slot sensor 26, as described in more detail below. The information on the number of vials in each slot 18 is transmitted by each slot controller 275 to the central slot controller 276. This information is then transmitted to the control system 28 to determine in which slot 18 to store a vial exiting the ADS 12.

Initially, a script is entered into the control system 272 of the ADS 12 by an operator. When entering the script, the operator preferably also enters identifying information for the script, such as a patient's name. Further, a unique bar code is associated with the script, and the bar code is preferably placed on any paperwork for the script; the purpose of which will be described below.

Once the script is entered, the ADS 12 automatically fills a vial with the correct medicament, labels the vial with the identifying information and bar code for the script, and conveys the vial to the ACC 10 via the outfeed conveyor 32, as described above. The control system 272 of the ADS 12 sends the script information to the control system 28 of the ACC 10, including the patient's name, the script number, and the vial size. Although the ACC 10 knows the size of the vial from the information relayed by the ADS 12, the first and second vial dimension sensors 22a,22b confirm the vial's height and diameter as a safety precaution, as described in more detail below.

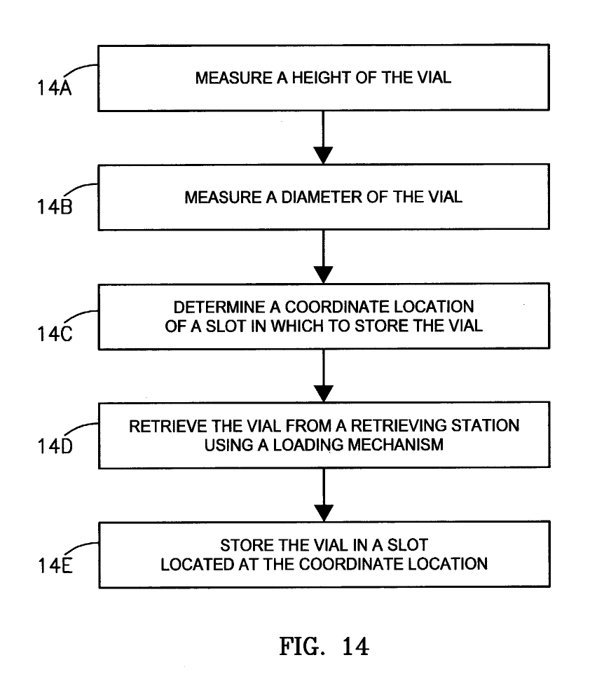

As the vial proceeds along the infeed conveyor 20 of the ACC 10, the vial's height is measured by the first vial dimension sensor 22a, as depicted in box 14A of FIG. 14. The control system 28 of the ACC 10 determines the vial's height and equates the height with a particular sized vial. This information is transmitted to the control system 272 of the ADS 12 via the central slot controller 276. Information regarding the height of the vial is also transmitted to the central slot controller 276 so that the control system 272 of the ADS 10 knows which slots 18 contain particular vials and whether particular slots 18 are currently storing filled vials.

Next, the vial's diameter is measured by the second vial dimension sensor 22b, as depicted in box 14B. As with the first vial dimension sensor 22a, the control system 28 determines the vial's diameter and equates the diameter with a particular sized vial. This information is also transmitted to the control system 272 of the ADS 12 via the central slot controller 276.

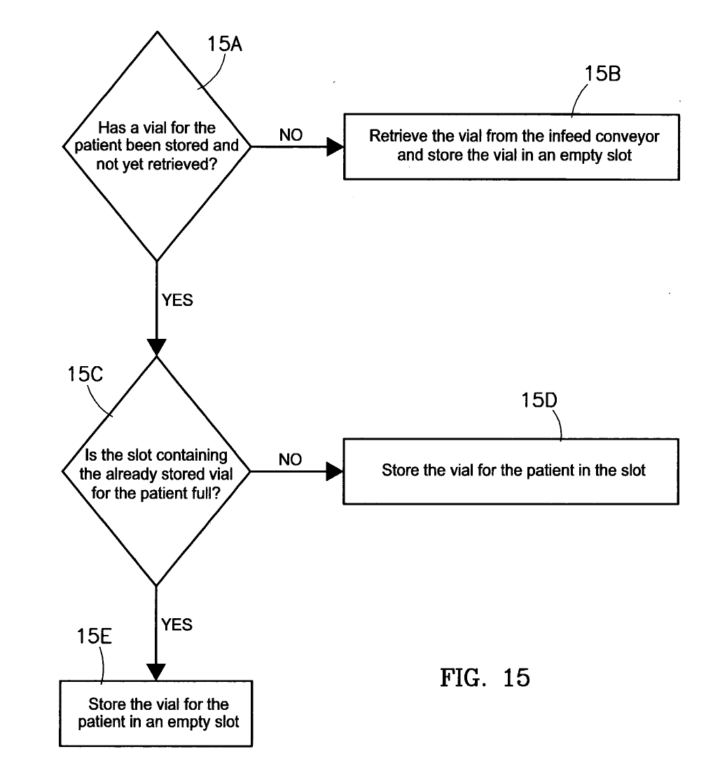

After the height and diameter of the vial are measured, the vial is positioned for retrieval by the loading mechanism 24 and storage in the slot matrix 16. The control system 28 determines in which slot 18 to store the vial and the coordinate location of the slot 18, as depicted in box 14C. The following algorithm is used to determine in which slot 18 to store the vial, the steps of which are depicted in FIG. 15. The control system 28 first determines if any other vial for a particular patient has been stored in the slot matrix 16 and not yet retrieved by the operator, as depicted in step 15A. If no vial for the patient has been previously stored, then the control system 28 instructs the loading mechanism 24 to retrieve the vial from the infeed conveyor 20 and store the vial in an empty slot 18, as depicted in step 15B. If a vial for the patient has already been stored, and the current vial to be stored is also for the same patient, the control system 28 determines if the slot 18 containing the already stored vial is full, as depicted in step 15C. If the slot 18 is not full, then the control system 28 instructs the loading mechanism 24 to retrieve the vial from the infeed conveyor 20 and store the vial in the particular slot 18 containing the already stored vial for the particular patient, as depicted in step 15D. If the slot 18 is full, then the control system 28 instructs the loading mechanism 24 to place the vial in an empty slot 18, as depicted in step 15E.

With regard to the receivers 294 positioned on either side of the one-way swinging doors 78, when the doors 78 are opened, the receivers 294 are momentarily blocked, such that the slot sensor 26 momentarily detects less emitted infrared energy. This momentary block of energy is transmitted to the control system 28 via the central slot controller 276, such that the control system 28 knows that the doors 78 were opened. If the control system 28 determines that the doors 78 were not supposed to be opened, i.e. the control system 28 was not instructing the loading mechanism 24 to place a vial in the slot 18, then an error message is displayed for the operator, so that the operator can determine if the doors 78 malfunctioned or if an item was placed in the slot 18 that the control system 28 did not instruct to be placed there.

After determining in which slot 18 to store the vial, the control system 28 transmits the coordinates of the slot 18 to the loading mechanism controller 278 (“LMC”). The LMC 278 stores the location of each slot 18 in the memory 286 of the control system 28. The location of each slot 18 is stored in terms of the cylindrical coordinate of the slot 18 with respect to the movement of the loading mechanism 24. Once the coordinates for the slot 18 are obtained from the LMC 278, the LMC 278 instructs the loading mechanism 24 to retrieve the vial from the second vial dimension sensor 22b, as depicted in box 14D, and store the vial in the selected slot 18 as depicted in box 14E. Thus, the loading mechanism 24 is instructed by the LMC 278 on the required distance and angle of travel in the r, θ, and z-directions, as described above. The LMC 278 of the control system 28 further instructs the loading mechanism 24 in which location, i.e. the front or rear position within the slot 18 to store the vial. Therefore, the loading mechanism 24 will not push the vial so far into the slot 18 so as to disrupt an already stored vial. The loading mechanism 24 then loads the vial through the pair of one-way swinging doors 78 and snaps the vial into place in the holding members 84.

The LMC 278 also uses the measured height and diameter of the vial to ensure that the grasping member 188 grasps the vial in the correct location. The control system 28 is programmed to always grasp the vial at a predetermined distance from a top of the vial. This is to ensure that the vial is properly placed in the holding members 84 of the slot 18. As can be appreciated, if the vial was grasped too high, the vial may bump up against the slot 18 when being placed in the slot 18, which may dislodge the vial from the grasping member 188 or cause medicament to spill out from the vial. If the vial is grasped too low, when the loading mechanism 24 places the vial in the slot 18, the vial may not snap into position in the holding members 84, thus causing the vial to drop to the slot floor and medicament to spill out. Therefore, the control system 28 instructs the loading mechanism 24 to grasp the vial at the predetermined distance from the top of the vial. Since the distance the loading mechanism 24 must move to grasp the vial at the predetermined distance from the top of the vial varies with the height of the vial, it is necessary to measure the height of the vial.

Similarly, the LMC 278 also uses the diameter of the vial to instruct the loading mechanism 24 on how much to grasp the vial. Since the fourth motor 234 is not encoded, the motor 234 is limited to only moving the distance instructed by the LMC 278. So as to not grasp the vial enough or to grasp the vial too much, the LMC 278 instructs the grasping member 188 of the loading mechanism 24 on how far to move to adequately grasp the vial.

Once the vial is stored in the slot 18, the slot sensor 26 recognizes that the vial is located in the slot 18 and transmits such information to the central slot controller 276, as noted above. The central slot controller 276 then transmits the same information to the control system 272 of the ADS 12. The central slot controller 276 also instructs the individual slot controller 275 for the slot 18 to display the patient's name, the script, or other pertinent information on the indicator 296 of the slot 18, as illustrated in FIG. 2.

Should the slot sensor 26 report that the vial is not stored in the slot 18, the control system 28 displays an error message. This is a security feature to ensure that the vial is not misplaced in the slot 18 or in another slot. The same error checking procedure is performed for all vials placed in all slots 18.

As another added security feature, the LEDs 290 of the slot sensor 26 continuously emit infrared energy, and the control system 28 of the present invention continuously monitors whether a vial is located within the slot 18. This is to ensure that no vial is located in the slot 18 that the control system 28 does not recognize. For example, if the operator or other third-party stores a vial or other item in the slot 18, the slot sensor 26 recognizes that the slot 18 now contains the vial stored by the operator.. This information is transmitted to the control system 28, which recognizes that the loading mechanism 24 did not place the vial in the slot 18 and thus, the vial is not one of the vials monitored by the control system 28. The control system 28 then registers the slot 18 as unusable. Preferably, the control system 28 also generates an error message for the operator on the display 284, which instructs the operator that a foreign, unknown object is located in the slot 18.

When the operator is ready to retrieve one or more vials, the operator may locate the vial using one of the following procedures:

(1) find the correct location of the vial from the information displayed on the indicator 296;

(2) highlight the script on a display (not shown) of the ADS 12 using either an input device (not shown) or an indicia reader (not shown) of the ADS' control system 272; or

(3) highlight the script on the display 284 of the ACC's control system 28 using either the input device 280 or the indicia reader 282.

If the slot matrix 16 is full, or even half-full, with stored vials, locating the correct slot 18 may be time-consuming. Therefore, the present invention allows the operator to highlight the locating information either using the input device 280 or the indicia reader 282 and either on the ADS' display (not shown) or the ACC's display 284. The method of the second and third options above are substantially similar, and therefore, only the third option will be described.

To retrieve the vial from the slot matrix 16 using the patient's name, for example, the operator may input the patient's name into the control system 28 by either typing the name using the keyboard, highlighting the name on the display 284 using the mouse, touching the name on the display 284 if the control system 28 includes touch-screen software, or any other suitable method. Preferably, the indicator 296 for the slot 18 will flash, indicating the slot 18 contains the identified vial for the script. Alternatively, the operator may scan the bar code for the paperwork for the script using the indicia reader 282, also triggering flashing of the indicator 296.

As another added security feature, the control system 28 will not place a vial for a patient in a slot 18 already containing a vial for a different patient, i.e. the control system 28 will not mix scripts, until all vials for the original patient have been removed from the slot 18. This ensures that upon retrieval of the vials by the operator, the operator knows to retrieve all vials within the slot 18, because the control system 28 will only load vials within the slot 18 belonging to the same patient. Therefore, the operator need not look at each vial to determine if the vial is for the patient.

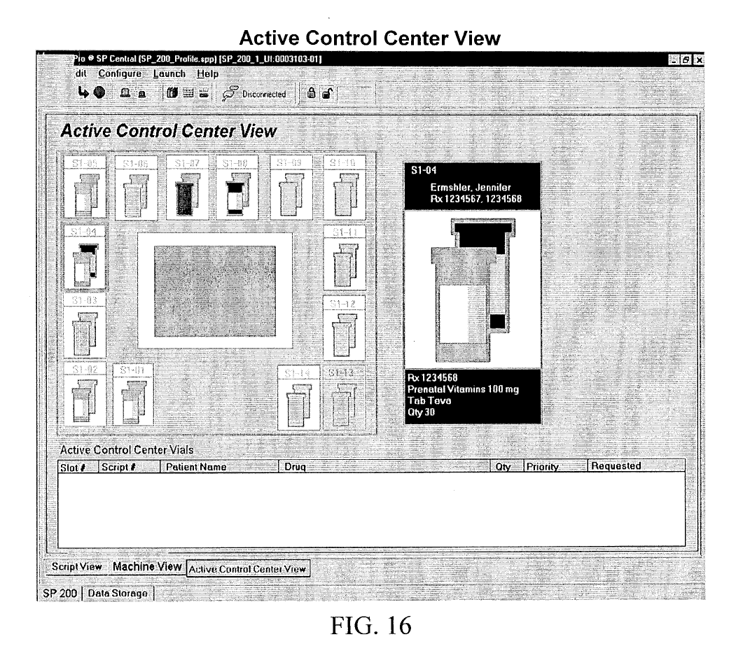

The display 284 of the control system 28 is operable to display the arrangement of the slots 18 in the slot matrix 16, as illustrated in FIG. 16. Further, the display 284 is operable to indicate the number of vials in each slot 18. When the operator highlights, scans, or otherwise inputs the identifying information for the patient into the control system 28, the location of the slot 18 containing the vial associated with the identifying information is highlighted on the display 284. Further, the display 284 also indicates the location of the vials within each slot 18, i.e. the first, second, or third positions within the slot 18. Thus, the display 284 also provides another option for the operator to quickly and easily locate the slot 18 containing the desired vial. Once the vial is pulled from the slot 18, the display 284 de-highlights the slot 18, which indicates to the operator that no vials are contained in the slot 18.

Once all vials are retrieved from the slot 18, the control system 28 closes the script to indicate that all vials for the patient have been retrieved. As a further added security feature, after retrieval of the vials from the slot 18, the slot sensor 26 automatically determines whether any vials were not retrieved. If vials remain in the slot 18, the slot sensor 26 transmits such information to the control system 28, and the control system 28 instructs an error message to be displayed on the display 284. This alerts a busy operator that not all vials were retrieved for the patient and prevents the mixing of vials so that the wrong script is not given to the patient. Upon removal of all vials from the slot 18, the control system 28 registers the slot 18 as empty and operable to store additional vials.

Although the invention has been described with reference to the preferred embodiment illustrated in the attached drawing figures, it is noted that equivalents may be employed and substitutions made herein without departing from the scope of the invention as recited in the claims. For example, the slot matrix 16 may be sized to include fewer or more slots 18. The infeed conveyor 20 may be eliminated, and filled vials may be placed in a location for direct retrieval by the loading mechanism 24. Additionally, the first and second vial dimension sensors 22a,22b for measuring the height and diameter of the vial may be combined into one vial dimension sensor. Further, although the active control center 10 of the present invention is particularly useful for storing filled prescription vials, it may also be used to store other products and goods.

Having thus described the preferred embodiment of the invention, what is claimed as new and desired to be protected by Letters Patent includes the following:

1. A control center for storing vials filled by an automatic dispensing system, the control center comprising:
a slot matrix having a plurality of slots, wherein each slot is configured for holding at least one medicament vial;
a computer-controlled mechanical loading mechanism for automatically storing a vial in the slot matrix;
a slot sensor contained within each slot for determining how many vials are held within the slot; and
a control system for controlling operation of the computer-controlled mechanical loading mechanism and the slot sensor in response to prescriptions received from a host computer.

2. The control center as set forth in claim 1, further including a cabinet for supporting the slot matrix.

3. The control center as set forth in claim 2, further including at least one vial dimension sensor for determining at least one dimension of the vial.

4. The control center as set forth in claim 3, wherein the vial dimension sensor determines a height of the vial.

5. The control center as set forth in claim 4, wherein the control center includes an infeed conveyor that is an outfeed conveyor of the automatic dispensing system.

6. The control center as set forth in claim 5, wherein the control system stores the vial in the slot based on a patient name for whom the vial is intended and the availability of an open position in the slot.

7. A control center for storing vials filled by an automatic dispensing system, the control center comprising:
a slot matrix having a plurality of slots, wherein each slot is configured for holding at least one medicament vial; and
a computer-controlled mechanical loading mechanism for automatically storing the vial in the slot matrix, the loading mechanism including—a base;
a plate lying generally parallel to the base and operable to rotate about an axis generally perpendicular to the plate;
a first motor for driving the rotation of the plate;
a vertical tower extending upwardly from the plate;
a horizontal grasping arm secured generally perpendicular to the tower and operable to move vertically along a length of the tower;
a second motor for driving the horizontal grasping arm along the length of the tower;
a third motor for driving the horizontal grasping arm in a horizontal direction; and
a grasping member secured to the horizontal grasping arm for grasping and locating the vial in the slot matrix.

8. The control center as set forth in claim 7, wherein the loading mechanism is operable to move in three directions.

9. The control center as set forth in claim 8, further including a control system for controlling operation of the loading mechanism.

10. A control center for storing vials filled by an automatic dispensing system, the control center comprising:
a cabinet;
a slot matrix positioned on the cabinet and having a plurality of slots, wherein each slot is configured for holding at least one medicament vial;
an infeed conveyor for transporting a vial from the automatic dispensing system to the control center;
at least one vial dimension sensor for determining at least one dimension of the vial;
a computer-controlled mechanical loading mechanism for retrieving the vial from the infeed conveyor and moving the vial to the slot matrix;
a slot sensor contained within each slot for determining how many vials are held within the slot; and
a control system for controlling operation of the infeed conveyor, the vial dimension sensor, the computer-controlled mechanical loading mechanism, and the slot sensor in response to prescriptions received from a host computer.

11. The control center as set forth in claim 10, wherein the control center is substantially adjacent to the automatic dispensing system such that the infeed conveyor of the control center is an outfeed conveyor of the automatic dispensing system.

12. The control center as set forth in claim 11, wherein each slot includes a slot controller that controls the slot sensor for the slot.

13. The control center as set forth in claim 12, wherein the vial dimension sensor is a first vial dimension sensor for measuring a height of the vial, and the control center further includes a second vial dimension sensor for measuring a diameter of the vial.

14. The control center as set forth in claim 13, wherein the slot is configured to hold two vials at once.

15. The control center as set forth in claim 14, the computer-controlled loading mechanism including
a base secured within the cabinet,
a plate lying generally parallel to the base and operable to rotate about an axis generally perpendicular to the plate,
a first motor for driving the rotation of the plate,
a vertical tower extending upwardly from the plate,
a horizontal grasping arm secured generally perpendicular to the tower and operable to move vertically along a length of the tower,
a second motor for driving the horizontal grasping arm along the length of the tower,
a third motor for driving the horizontal grasping arm in a horizontal direction, and
a grasping member secured to the horizontal grasping arm for grasping the filled vial and locating the vial in the slot matrix.

16. The control center as set forth in claim 15, the control system including
a central slot controller for controlling operation of each slot controller,
a loading mechanism controller for controlling operation of the computer-controlled mechanical loading mechanism,
an input device,
an indicia reader, and
at least one display that serves as an operator interface.

17. A method of storing filled medicament vials, the method comprising the steps of:
measuring a height of the vial;
measuring a diameter of the vial;
determining a coordinate location of a slot in which to store the vial;
retrieving the vial from a retrieving station using a loading mechanism; and
storing the vial in the slot located by the coordinate location, wherein the control system identifies the vial stored in the slot based on identifying information.

18. The method as claimed in claim 17, wherein the height of the vial is measured to ensure the vial is retrieved by the computer-controlled mechanical loading mechanism at a predetermined location on the vial, and the diameter of the vial is measured to facilitate grasping of the vial by the loading mechanism.

19. The method as claimed in claim 18, wherein the slot is formed in a slot matrix that includes a plurality of slots.

20. The method as claimed in claim 19, further including the steps of:
when retrieval of the stored vial is desired, inputting the identifying information into the control system; and
highlighting a display associated with the slot, wherein the display displays the identifying information for the vial to facilitate location of the slot in the slot matrix.

21. The method as claimed in claim 20, wherein the coordinate location is determined based on the identifying information and the availability of an open position in the slots.
